(19) United States
(12) Patent Application Publication
(10) Pub. No.: US 2015/0358052 A1
(43) Pub. Date: Dec. 10, 2015

(54) COMMUNICATIONS SYSTEM IN AN AIRCRAFT WITH A NEAR-FIELD COMMUNICATIONS INTERFACE

(71) Applicant: LUFTHANSA TECHNIK AG, Hamburg (DE)

(72) Inventor: ANDREW MUIRHEAD, NORDERSTEDT (DE)

(21) Appl. No.: 14/432,418

(22) PCT Filed: Sep. 26, 2013
(86) PCT No.: PCT/EP2013/070115

§ 371 Date: Mar. 30, 2015

(30) Foreign Application Priority Data
Sep. 28, 2012 (DE) 10 2012 217 797.3

(51) Int. Cl. H04B 5/00

(52) U.S. Cl. CPC H04B 5/0025

(57) ABSTRACT

The invention concerns a communications system in an aircraft, which system enables communication to take place between a passenger and an onboard communications arrangement. The communications arrangement comprises a near-field communications interface which is arranged for communication with a passenger appliance and/or a passenger transponder element.

The invention relates to a communication system in an aircraft, which communication system enables a communication between a passenger and a communication unit on board the aircraft.

There are various possibilities for passengers in the cabin of an aircraft to connect to a communication unit on board the aircraft.

Usually there are call buttons for the passengers at the seats in the aircraft with the aid of which the passengers can call the cabin crew in a simple way. As a rule, a light arranged under the overhead compartment illuminates.

Furthermore, there is often the possibility for the passengers to use an in-flight entertainment system with a screen at the seat and, for example, to watch various films during the flight. Corresponding audio entertainment can be made available to the passenger at the seat via a headphone jack. Billing for special services or individual services is not possible.

Furthermore, passengers in the cabins of aircraft with appropriate equipment can use content from an in-flight entertainment system with the aid of passenger devices that the passengers bring with them via a wireless network access point, e.g. WLAN, in the aircraft. Furthermore, the passenger can have access to the internet with his/her passenger device via such a wireless connection, wherein the internet connection can be established via a powerful wireless unit of the aircraft, e.g. satellite-based. Connecting the passenger devices and associating the data connections used therewith can take place in advance of the flight by means of a corresponding additional booking, wherein the passenger receives a corresponding code for connecting his/her passenger device to the wireless network of the aircraft.

Passenger devices can be mobile telephones or portable computers or any mixed form of these two device types such as, for example, smartphones or tablet PCs. The passengers on a flight bring the passenger devices with them in the aircraft and the passengers can use said passenger devices there.

In addition, goods and services are often sold in the cabin of an aircraft during the flight, where payments can be made in cash or by means of card readers for debit and/or credit cards. Payment in cash is cumbersome in international travel since the large number of possible currencies makes a limitation to a few currencies necessary for organisational reasons. In addition, the cabin crew must have appropriate sums of change on every flight. Card payments with debit or credit cards requires the personal involvement of the cabin crew since conventional card readers are used by the cabin crew in the cabin. Furthermore, a manual comparison of signatures is generally required for verifying the payment process. For conventional card payments, managing a large number of smaller individual amounts for each passenger during the flight is very inefficient.

If the services purchased involve electronic offerings on board, such as an in-flight entertainment system or a wireless network, manual feedback from the cabin crew to these electronic systems is necessary in conventional payment methods in order to associate the payment process with the relevant passenger in the aircraft.

The object of the invention is to provide a communication system in an aircraft which overcomes the above-mentioned disadvantages.

The object of the invention is achieved, proceeding from the preamble of claim 1, by the characterising features of said claim. A communication system in an aircraft enables a communication between a passenger and a communication unit on board the aircraft. According to the invention, the communication unit has a near-field communication interface which is designed to communicate with a passenger device and/or a passenger transponder element.

The near-field communication interface enables a passenger to communicate digitally with on-board electronic systems by means of his/her passenger device, wherein, by means of the use of the near-field communication interface, the communication explicitly can only take place between two communication partners, in this case between the passenger device and the corresponding communication unit.

The communication interface preferably can have a closed surface without sockets and slots, as a result of which the communication unit is resistant to mechanical influences from passengers. This contributes to improved operating security and a high reliability of the communication unit. For example, children travelling with passengers cannot mechanically manipulate a corresponding communication unit or insert objects into sockets or slots. The near-field communication interface enables a shallow installation depth, and so the installation location in the cabin of an aircraft can to a large extent be chosen freely.

The communication unit is preferably assigned to a specific seat. It is therefore advantageous to assign a communication unit to each seat or to each of a plurality of seats in the aircraft. The passenger thus has a communication unit available at his/her seat, and so the passenger can use his/her passenger device and/or passenger transponder element directly at his/her seat for communicating with the communication unit. The passenger can thus also obtain an input option for on-board electronic systems of the aircraft. On-board electronic systems can be an in-flight entertainment system, a call system for service staff or data access.

Assigning the near-field communication interface to a seat can, in particular, lead to a significant simplification of the payment processes in an aircraft. Payments for goods and services in the aircraft can therefore be carried out quickly and efficiently with little involvement of staff. The passenger can pay for electronic offerings at short notice in the aircraft, without any intervention from the cabin crew being required since, for example, an automatic configuration of the in-flight entertainment system can take place after a successful payment process. Controlling an in-flight entertainment system on a per-seat basis can be coupled to the communication system in an advantageous way.

Many services in an aircraft, such as meals and drinks which differ from the standard or goods sold in the aircraft, can be billed on a per-seat basis since the passengers usually keep their seat during the flight and the goods and services are mostly received at the seat, and so assigning seats to communication units with near-field communication interfaces is advantageous for payments.

Furthermore, it is possible to assign a plurality of seats to a communication unit, and so, for example, two seats arranged next to each other have access to a single communication unit.

The seat assignment enables information to be displayed to the cabin crew in a simple way regarding from which seat an order, note and/or payment originated, and so the cabin crew can easily provide the corresponding service at the correct seat.

The communication unit preferably has a data connection to a central data-processing unit of the aircraft. This enables centralised management in the aircraft, and so the operation of the communication system can be implemented in a simple way. Furthermore, interfaces to an in-flight entertainment system for media entertainment for the passengers and/or a wireless network access point for data connections according to WLAN standards, e.g. IEEE 802.11, for the passenger devices can be produced in a simple way by the central data-processing unit. Furthermore, a wireless unit of the aircraft can be controlled by the data-processing unit to allow the passenger devices to communicate externally via the wireless unit. In addition, a power distribution unit can control the distribution of power to power outlets in the cabin for the passengers via the data connection between the communication unit and the central data-processing unit.

The communication unit is preferably designed to read a digital identifier and/or signature of an associated passenger device and/or passenger transponder element.

Such a digital identifier can be, for example, a MAC address of network adapters of the passenger device. This allows a passenger device to be recognised again easily once it has been registered, which facilitates the later authentication and later establishing of connections during the flight. The digital identifier and/or signature can be used for other communication channels in addition to the near-field communication, such as for example in a wired data network for the passenger or a cabin-wide wireless network. Furthermore, by means of the unique identifier, passenger device-specific assignments of electronic services can be used.

In an advantageous embodiment, the digital identifier of the passenger device and/or the passenger transponder element can is be read by the near-field communication interface. This initially enables a secured transmission of the digital identifier and/or the signature in a near-field communication between the communication unit and the passenger device, which can take place, for example, in conjunction with a secured payment process by means of near-field communication, and so this passenger device can then establish a connection to a wireless network in the aircraft using the digital identifier of said passenger device and use the wireless network according to a payment process. With the digital identifier, various electronic services can subsequently be unlocked for this passenger device with this digital identifier.

By means of the near-field communication interface in the communication unit, only one passenger device at a time can communicate with the communication unit, which enables a passenger device to be uniquely associated with a seat without the use of a cable and without further manual input regarding the relevant seat being necessary. This is particularly advantageous for payment processes.

Advantageously, an assignment of seats to passenger devices and/or passenger transponder elements can be stored in the central data-processing unit. This simplifies the use and operation of the communication system, in particular in the case of any possible involvement of cabin crew. In addition, this enables per-seat feedback from the data-processing unit to individual seats via the corresponding passenger devices.

The near-field communication interface is preferably designed to transmit an identifier and/or a password for a wireless network of the aircraft to the passenger device. The identifier and/or the password can therefore be transmitted, via a wired connection which is secure against interception, to a specific passenger device, which is determined by the seat, in which way the passenger device can be identified unambiguously as the correct communication partner by means of the near-field communication interface of the communication unit.

The communication unit preferably has a power outlet for supplying low-voltage power to a passenger device. This enables the passenger device to be charged and/or operated at the passenger's seat without the use of a charging device or transformer belonging to the passenger. Most passenger devices require a 5 V to 12 V DC voltage power supply which can be made available via the power outlet for low-voltage power supply. In this way, no socket with voltages above 24 V, which are dangerous for people, is required at the passenger's seat. Furthermore, the low-voltage power con be provided centrally by the aircraft systems, as a result of which the efficiency of the overall power supply of the cabin in the aircraft, including the passenger devices, can be increased. Moreover, charging devices belonging to the passengers may result in a fire risk, since these devices can be used without having been serviced and in an unregulated way. Due to the appropriate low-voltage power supply at the power outlet of the communication unit, such charging devices belonging to the passengers are superfluous, which can reduce their use on board and therefore can contribute to improving safety, e.g. against fires due to short circuits.

In a preferred embodiment, the communication unit has a plug connector for a wired data connection between the passenger device and a central data-processing unit of the aircraft. This can be advantageous for a fast data connection, and in particular is positive when there are many passengers each with active passenger devices in the aircraft since e.g. a mutually negative influence of the passenger devices in a wireless network due to the limited bandwidth of the wireless channels can be ruled out. Furthermore, the transmission power of the individual devices required in a wireless network is reduced, which can lead to a lower electromagnetic load on the on-board systems. A wired data connection via a plug connector on the communication unit can be particularly advantageous if a cable is already used to connect the passenger device to the power outlet on the communication unit. A combination in a single connector, which most mobile telephones, smartphones or tablet PCs provide for, is advantageous here. Such a connector can, for example, comply with the USB standard.

The communication unit preferably has a holder for holding the passenger device. The holder can enable the passenger devices to be securely mounted within reach of the passengers, with the plurality of functions of the passenger devices preferably remaining usable for the passenger while in the holder. Furthermore, the passenger device is preferably held by the holder in such a way that the near-field communication interface of the communication unit and the corresponding passenger device are within communication range. By means of the holder, the passenger device can be used independently of the table at the time when meals are served on the conventional folding table.

In an advantageous embodiment, the communication unit has a screen and/or an input region. A screen with an input region on the communication unit, which preferably is arranged at every seat in the cabin, can be used independently of the screen of a possible in-flight entertainment system in order to display flight information, menus for food and drinks and information regarding the payment functions by means of near-field communication NFC. Furthermore, various requests, e.g. fastening seatbelts or placing the seat in the upright position, can be displayed.

Advantageously, the communication unit has an audio system, wherein the audio system has at least one loudspeaker. Using a loudspeaker, which preferably is installed on the seat in the region of the head of the passenger, makes it unnecessary to use headphones which must be plugged in. The loudspeaker(s) is/are assigned to an individual seat for this purpose. The audio system can be controlled, for example, via the in-flight entertainment system, via an on-board intercom system and/or via the passenger devices. The passenger device can be connected to the communication unit of the communication system for this purpose via a corresponding connection. The connection can be established e.g. via a jack plug, preferably 3.5 mm according to IEC 60603-11, and/or via a USB connector.

The audio system preferably has an audio amplifier. A corresponding audio amplifier can be significantly higher powered than is possible with the integrated amplifiers in the passenger device. This can furthermore result in a reduced burden on the batteries of the passenger device. The passenger device can, in this case, also be a music playback device without additional functionality. The amplification by an audio amplifier of the audio system is particularly advantageous if the sound is played back with a loudspeaker in the cabin at the seat, and in particular if no additional connected headphones are used.

The following features are also inventive as such independently of the invention.

An audio system for a cabin of an aircraft, wherein the audio system is assigned to a seat of a passenger for individual sound exposure of the individual passenger, and the audio system has at least one individual loudspeaker fixedly mounted on the seat, is inventive. The audio system has an individual audio amplifier for amplifying the audio signal, wherein the audio system is designed to play back an audio signal received from a passenger device of the passenger. This is particularly advantageous for enabling individual playback of different sound information, e.g. music, in the cabin of the aircraft for each individual passenger where, due to the fixedly mounted loudspeakers, no headphones or in-ear headphones are necessary for the passenger to hear the individual sound information.

The audio system preferably has an analogue audio input. An audio signal can thereby be transmitted in an advantageous way from a passenger device to the audio system installed in the aircraft.

Furthermore, in an advantageous embodiment, the audio system has a data audio input. This data audio input can receive a digital audio signal which is transmitted from a passenger device. The data audio input can, for example, be designed in the form of a USB data connector.

The loudspeakers are preferably integrated into the aircraft seat of this seat. The loudspeakers can, for example, be integrated in the aircraft seat in the region of the headrest, and so these can be used for playing back sound information in the region of the passenger's ears.

In an advantageous embodiment, at least a part of the audio system is arranged on a further aircraft seat which is located in front of the passenger's seat, wherein the audio signal is preferably received in the part of the audio system in the further aircraft seat. In this way, the passenger device can, for example, be located on the further aircraft seat and can transmit the audio signal there to a part of the audio system, e.g. with an analogue audio connector. The data can, for example, be transmitted between the two aircraft seats via a Bluetooth connection, wherein an association can be made in particular by storing the pairing identifiers in the audio system and/or in the communication unit of an aircraft seat and the other part of the audio system in the further aircraft seat. Alternatively, the audio signal can, for example, be transmitted by means of a cable, a so-called feedback cable, between the aircraft seats, in particular from the front seat to the rear seat.

The invention is explained below on the basis of preferred embodiments with reference to the appended drawings. In the drawings:

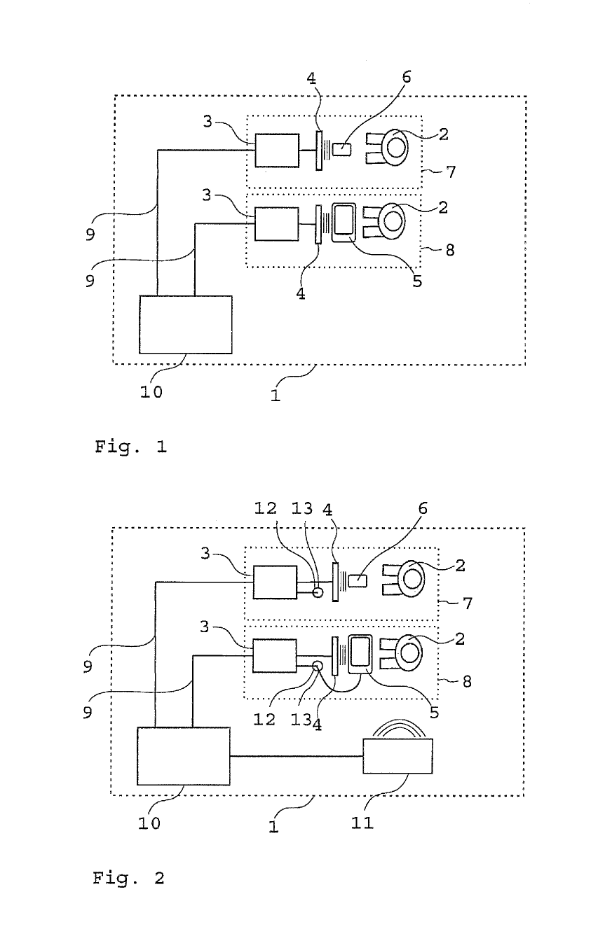

FIG. 1 shows a communication system in an aircraft;

FIG. 2 shows a communication system with additional data connections;

FIG. 3 shows a communication unit in an aircraft seat; and

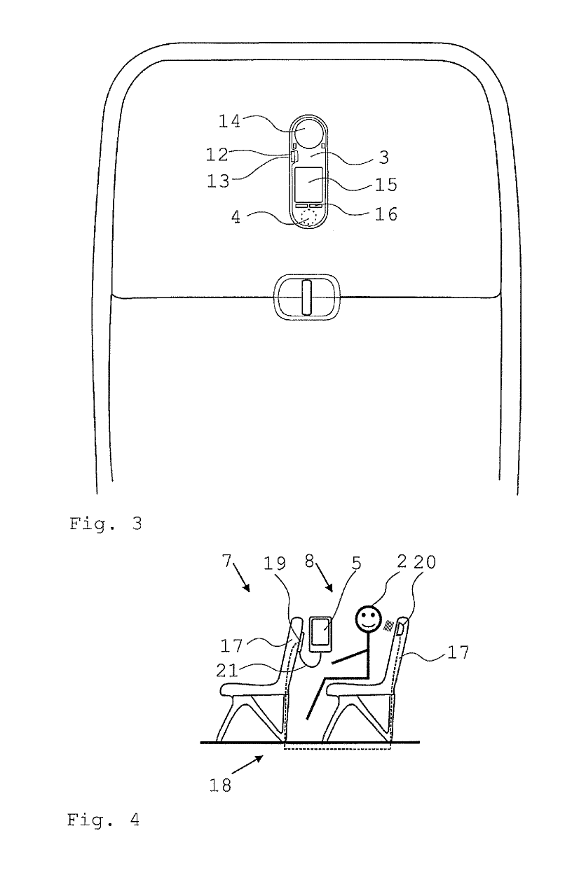

FIG. 4 shows an audio system in an aircraft.

FIG. 1 shows an embodiment of a communication system 1 in an aircraft represented schematically. In this embodiment, the aircraft has two seats 7, 8, on each of which a passenger 2 sits. A communication unit 3 on board the aircraft is arranged on each of the two seats 7, 8 with each unit having a near-field communication interface 4. In this advantageous embodiment, the communication units 3 have a data connection 9 to a central data-processing unit 10 of the aircraft, which preferably is a wired connection. In alternative embodiments, a wireless data connection 9 can be available between the communication units 3 and the central data-processing unit 10.

The communication units 3 are advantageously assigned to individual seats 7, 8, wherein the assignment of communication units 3 and near-field communication interfaces 4 can be stored in the central data-processing unit 10, by means of which data and/or information transmitted from a communication unit 3 to the central data-processing unit 10 can be associated with a specific seat 7, 8.

In this embodiment, the passengers 2 bring a passenger device 5 with near-field communication capability and a passenger transponder element 6 with them. The passenger device 5 can be, for example, a smartphone which is designed for near-field communication (NFC) according to an international standard, e.g. according to ISO/IEC 13157. The near-field communication interfaces 4 are correspondingly designed for such a data transmission. In this embodiment, the passenger transponder element 6 is a bank card which takes a passive role in the communication when communicating with a near-field communication interface 3 and therefore does not require its own power supply. The passenger transponder element 6 can be operated, for example, by means of the electromagnetic field of the near-field communication interface 3. A passenger device 5, in contrast to a passenger transponder element 6, can communicate passively or actively with the near-field communication interface 3. NFC can be differentiated from radio-frequency identification (RFID) by the possibility for a two-way communication.

In the embodiment in FIG. 1, a passenger 2 uses his/her passenger transponder element 6, his/her NFC-capable bank card, to pay for a service at his/her seat 7 during the flight. Such a service can be, for example, an expanded range of content for an in-flight entertainment system which is available to the passenger at his/her seat 7 via a corresponding output unit, such as e.g. a monitor. The payment for this service can be associated with a seat 7 by the central data-processing unit 10 and thus, by means of a connection between the data-processing unit 10 and the in-flight entertainment system, the latter can be controlled accordingly at the seat 7.

The second passenger 2 in FIG. 1 uses his/her passenger device 5 to carry out a payment process. This payment process is carried out by means of a contactless data exchange between the passenger device 5 and the near-field communication interface 4 according to a transmission standard for near-field communication, preferably a secured transmission standard. Contactless data exchange is only possible over a few centimetres with the near-field communication interface.

FIG. 2 shows a communication system 1 in which the communication units 3 have a power outlet 12 for supplying low-voltage power. The passenger 2 has connected his/her passenger device 5 to the power outlet 12, and so the passenger device 5 can be charged and/or operated without an additional power supply. In an advantageous embodiment, the voltage of such a power outlet is 5 V DC voltage.

Furthermore, the communication units 3 in the embodiment in FIG. 2 have a plug connector 13 for a wired data connection, wherein a wired transmission of data between the passenger device 5 and the communication unit 3 is possible by means of the plug connector 13. The corresponding data can be further transmitted to the central data-processing unit 10 via the data connection 9, and so a wired transmission of data between a passenger device 5 and the central data-processing unit 10 is possible. This wired transmission of data can be used in parallel with the near-field communication interface if, for example, a higher transfer rate is necessary for specific content.

In this advantageous embodiment, the power outlet 12 for supplying the low-voltage power and the plug connector 13 for the wired data connection are combined in a USB connector so that the passenger 2 can use both connectors with a single cable.

In a possible embodiment, the passenger 2 would like to use internet access in the aircraft via the wireless units of the aircraft. To do so, the passenger moves his/her passenger device 5 to the near-field communication interface 4 of the communication unit 3 at his/her seat 8. The passenger 2 confirms the payment of a corresponding amount on his/her passenger device 5, for example for unlimited use of an internet connection during the flight which is intended to be made available to the passenger 2 on his/her passenger device 5. After the payment, the near-field communication interface reads a digital identifier, for example in the form of the MAC address of the WLAN adapter of the passenger device 5. Additionally or alternatively, a password for the wireless network 11 in the aircraft can be transmitted to the passenger device 5 by means of the near-field communication interface 4. The limited range of the near-field communication in this case ensures that the password is transmitted to the correct passenger device 5 and to only one such device.

The passenger 2 can log into the wireless network 11 with his/her passenger device 5 by means of the password, can use the data connection according to the payment process he/she has already carried out and can exchange data with the internet via the wireless units of the aircraft.

In a further advantageous embodiment, after the payment process by means of near-field communication between the passenger device 5 and the near-field communication interface, the passenger 2 connects the passenger device 5 to the plug connector 13 with a cable, for example for Internet usage. The communication unit 3 reads the corresponding hardware identifier in the form of a MAC address and stores this in the central data-processing unit 10. The passenger 2 can therefore receive internet access on his/her passenger device 5 via the communication unit 3 over the further course of the flight. The corresponding association of the payment process can be achieved via the association of the plug connector 13 and the communication unit 3 with the near-field communication interface 4. Alternatively, the association can be made via the digital identifier of the passenger device 5, and so the corresponding internet access remains available to the passenger if the passenger changes seats in the aircraft during the flight.

Furthermore, contents from an in-flight entertainment system which can also be transmitted to the passenger device 5 can be made usable for the passenger through a corresponding payment process. Assigning a payment process to a passenger or to his/her passenger device 5 can take place analogously to the internet use described above. The content from an in-flight entertainment system can accordingly be transmitted to the passenger device 5 via the wireless network 11 or via the plug connector 13.

FIG. 3 shows the rear side of an aircraft seat 17 in which a communication unit 3 is integrated. The communication unit has a near-field communication interface 4 which, in this embodiment, is arranged in the lower region of the communication unit. The plug connector 13 and the power outlet 12 in this embodiment are combined in a USB connector which is shown in FIG. 3 on the left side of the communication unit 3. The communication unit 3 has a screen 15 and an input region 16 for displaying information and, in particular, for visualising contactless payment processes by means of near-field communication. In an advantageous embodiment, the passenger 2 can therefore select various services on the screen 15 with the input region 16, and a corresponding amount to be paid is displayed. For carrying out a payment process, the passenger 2 can, for example, bring his/her passenger transponder element 6, on which corresponding payment data are stored, into a range of preferably less than 4 cm around the near-field communication interface 4, by means of which the passenger can carry out the payment process. If the passenger 2 uses a passenger device 5, the passenger can, in this advantageous embodiment, mount said device on the communication unit 3 by means of a holder 14, and so the passenger can use the passenger device 5 at his/her seat 7, 8. Advantageously, the passenger device 5 can be mounted with the holder 14 in such a way that, in the mounted state, said device can communicate with the near-field communication interface 4.

FIG. 4 shows an embodiment of an audio system 18 for a cabin of an aircraft. The audio system 18 here is assigned to a specific seat 8 in each case, and so the audio system can be used individually by each passenger 2 on a corresponding aircraft seat 17. The audio system 18 has a loudspeaker 20 which, in this embodiment, is integrated into the aircraft seat 17 in the region of the headrest. In a further advantageous embodiment, the audio system has two loudspeakers 20. The passenger 2 controls his/her passenger device 5 to play back sound information, for example music, which is stored on the passenger device 5. For this purpose, the passenger 2 connects his/her passenger device 5 to the audio input of the audio system 18, which in this embodiment is located on the backrest of a further aircraft seat 17 of the seat 7. The passenger 2 can mount the passenger device 5 there, for example with a holder 14.

The audio signal is transmitted to the audio input via an audio cable 21. The audio system 18 conveys the received audio signal to the loudspeaker 20 which is fixedly installed on the aircraft seat 17 of the seat 8. The audio signal is amplified s here by an audio amplifier of the audio system 18, and so the loudspeaker 20 can play back the sound information at a higher volume than would be possible with the signal power from a conventional passenger device 5. In this way, disruptive noises, in particular when the engines of the aircraft are running, can be drowned out. Using headphones by means of a corresponding connector can be possible with the audio system 18, however this is not necessary since the loudspeakers 20 can be used for playing back audio.

1-3. (canceled)

14. A communication system for use in an aircraft, comprising:
a communication unit, wherein the communication unit has a near field communication interface,
wherein the communication system enables a communication between a passenger and the communication unit on board an aircraft, wherein the communication unit is designed to communicate with a passenger device or a passenger transponder element.

15. The communication system according to claim 14, wherein the communication unit is assigned to a specific seat on the aircraft.

16. The communication system according to claim 14, wherein the communication unit has a data connection to a central data-processing unit on the aircraft.

17. The communication system according to claim 14, wherein the communication unit is designed to read a digital identifier, a signature of an associated passenger device and/or passenger transponder element.

18. The communication system according to claim 17, wherein the digital identifier of the passenger device and/or the passenger transponder element can be read using the near-field communication interface.

19. The communication system according to claim 17, wherein an assignment of seats to passenger devices and/or passenger transponder elements can be stored in the central data-processing unit.

20. The communication system according to claim 14, wherein the near-field communication interface is designed to transmit an identifier and/or a password for a wireless network of the aircraft to the passenger device.

21. The communication system according to claim 14, wherein the communication unit has a power outlet for supplying low-voltage power to a passenger device.

22. The communication system according to claim 14, wherein the communication unit has a plug connector for a wired data connection between the passenger device and a central data-processing unit of the aircraft.

23. The communication system according to claim 14, wherein the communication unit has a holder, wherein the holder is configured to hold the passenger device.

24. The communication system according to claim 14, wherein the communication unit has a screen and/or an input region.

25. The communication system according to claim 14, wherein the communication unit has an audio system, wherein the audio system has at least one loudspeaker.

26. The communication system according to claim 25, wherein the audio system has an audio amplifier.

27. The communication system according to claim 14, further comprising:
the central data-processing unit.

28. An airplane, comprising:
a communication system, wherein the communication system comprises:
a communication unit, wherein the communication unit has a near field communication interface,
wherein the communication system enables a communication between a passenger and the communication unit on board an aircraft, wherein the communication unit is designed to communicate with a passenger device or a passenger transponder element.
